(19) United States
(12) Patent Application Publication
(10) Pub. No.: US 2013/0156405 A1
(43) Pub. Date: Jun. 20, 2013

(54) Distributed Cloud-Based Synchronized Data and Bandwidth Intensive Image Processing

(71) Applicant: Chris Healer, New York, NY (US)

(72) Inventor: Chris Healer, New York, NY (US)

(21) Appl. No.: 13/717,696

(22) Filed: Dec. 17, 2012

Related U.S. Application Data
(60) Provisional application No. 61/570,824, filed on Dec. 15, 2011.
(60) Provisional application No. 61/646,004, filed on May 11, 2012.

(51) Int. Cl. H04N 5/91

(52) U.S. Cl. CPC H04N 5/91
USPC 386/278

(57) ABSTRACT

A rotoscoping method comprises the steps of providing a video, providing a plurality of editors, and editing the video on computers of the plurality of editors.

### This application claims the benefit of U.S. Provision Application Nos. 61/570,824 filed Dec. 15, 2011; and 61/646,004 filed May 11, 2012, all of which are hereby incorporated by reference.

### BACKGROUND

Rotoscoping is a difficult and time-consuming process. Digital rotoscoping (hereinafter equivalently referred to as “rotoscoping”) and other computationally intensive visual effects processes are frequently used in the film and television industry.

The attached appendices includes background on rotoscoping and visual effects processing. The appendices are intended to be exemplary rather than exhaustive; they are not intended to convey, suggest, or teach every aspect, problem, or solution in the field of visual effects, and image and video processing, or to describe the many processes known and used by those having ordinary skill in the art.

Appendix A includes U.S. Pat. No. 6,061,462 which discloses a digital rotoscoping process. Appendix B includes a paper describing some additional digital rotoscoping material: Aseem Agarwala, Aaron Hertzmann, David Salesin, Steven Seitz. Keyframe-Based Tracking for Rotoscoping and Animation. ACM Transactions on Graphics (Proceedings of SIGGRAPH 2004), 2004.

In one example of rotoscoping, a first video comprises a plurality of objects, for example a lead actor generally in the foreground and some type of background which may itself comprise many elements. The lead actor is digitally identified and extracted. This requires the manual intervention of a user (e.g. video editing expert or artist) to, for example, accurately identify and define the edges of lead actor (or any other element that will be extracted), select or define keyframes, ensure that the the frames between the keyframes (the “inbetweens”) are interpolated properly so that the extracted video element remains true, realistic, and smoothly animated, make refinements, and the like. When complete, the extracted object can be used or placed as an element in another video shot or new scene.

Similarly, in this example, a second video shot comprises multiple background objects, some of which are animated or contain motion. For example, the second video may have been shot separately from the first video, and the filmmaker desires to combine objects included in both of the videos into a third video or new scene. In order to do this, each object of the second video must also, and separately, be painstakingly identified, keyframes selected, edges defined through for example splines or masks, inbetweens generated, etc.

Thus all of the objects of all of the videos are masked or splined or otherwise isolated—operations which require many man-hours and powerful computers—and frames between the keyframes interpolated—operations that also require many man hours and are computationally intensive—so that they can exist separately from their original video. Other processing may include feathering of edges, motion blurring, shrinking or expanding portions of the elements, shadowing, and the like. Afterwards, the objects can be realistically combined with background video, the objects can be placed as desired, objects or isolated portions of objects can be modified, and the like, and other visual effects and filters can be added or applied to create the final video comprising all of the layered objects in a natural, realistic, and smoothly executed shot that appears as though it was filmed as one shot. Rotoscoping can furthermore be used to create new or impossible to film animations, improve or modify appearances of objects, and the like.

Thus in view of this basic example which merely touches on some of the complexities that are well known in the art of rotoscoping and visual effects, it can now be appreciated that rotoscoping requires an enormous number of man-hours and computing time, considerable user interaction, powerful computers, massive storage, and tremendous bandwidth to manipulate, store, and reassemble the colossal volume of video and all of their associated elements needed to produce even a short video such as a commercial or film trailer. It also requires significant organizational resources and physical space to manage, coordinate, and provide working space for the large staff of people needed for such work.

There is a need for systems and methods for distributing and coordinated editing of video and other bandwidth intensive application.

### SUMMARY

A rotoscoping method comprises the steps of providing a video, providing a plurality of editors, and editing the video on computers of the plurality of editors.

### DETAILED DESCRIPTION

Disclosed in the attached figures, which include exemplary screenshots and video sequences, is a cloud-based rotoscoping system and method. The systems and methods distribute the rotoscoping processes described above from a server over a network such as the internet to a plurality of client computers running an application. Client-side caching may be used.

At each client computer (for example a desktop computer or any other user computing device operable to communicate over the internet), an artist or video editor rotoscopes or otherwise edits the portion distributed to them via the application which runs at least in part in a web browser of the editor's computer.

Edits are transmitted by the application from each of the client computers and are received at the server. The server reassembles all of the edits and elements. In this way rotoscoping can be distributed in both space and time thereby reducing or eliminating many of the problems of time, expense, man-hours, computing power, and the like so prevalent in the prior art.

The application also compresses and/or significantly reduces the need to compress transmitted and received video, thereby reducing bandwidth requirements to a level that allows distributed operation over presently available and generally inexpensive internet infrastructure.

One such exemplary piece of code is shown in the figures along with resulting screenshots. The function orders scanlines of footage by affinity towards powers of two. Those scanlines of a frame which have a stronger affinity toward a lower power of two are loaded first, and so on. Fundamentally, this bypasses a voluminous amount of compression that would otherwise be required, and furthermore makes future compression much simpler or less crucial.

Some exemplary aspects of the client/web application include but are not limited to:

1) Time API for Footage
a) offset
b) remap

2) Time API for Rotos

3) Save/Load/Create Projects

4) Finish Overlay Node

5) Finish Join Node
a) compositing modes

6) Finish Roto Node
a) shape manipulation
   .) create/delete shapes
   i) add points
      1) adding a point should add a keyframe for all keyframes, not just the point
   ii) delete points
   iii) marquis points
   iv) transform handle
      1) rotation
      2) scale
      3) fix scaleFrom anchor
      4) fix encompass boundingBox (from scaled handles)
      5) fix encompass when changing frames
   v) key commands (z,e)
   vi) click on curve causes selection
   vii) soft edge movement should be theta/scale, not cartesian
   viii) shape locking
   viv) shapes should update if node is selected and rotoSpline is not selected
b) shape keyframes
   i) animation
   ii) curve editor
   iii) point interpolation
c) shape rendering
   i) motion blur
   ii) invert
d) creating rotospline should automatically create a new open shape

7) Viewer:
a) timeline cache marks
b) timeline keyframe marks
c) steps
d) change move/up events to document events
e) safari does not catch mousedown on svg with no objects present (selection marquis)
f) spacebar pushes viewer to full screen
g) stereo support
   i) loading
   ii) interlacing/anaglyph support (e.g. WebGL)
h) push settings from loaded file when node already exists

8) Switch Node
a) finish process( )

9) Preferences
:) load preferences from cookies or local db
a) cable tension?
b) footage server/port
c) stereo options
d) join view settings
e) controls mode
f) autosave
   i) saving a file should cause autosave's timer to reset

10) Curve Editor
a) selected items
b) editable

11) Animatable
a) Should set animatable.time to currentTime on project load or new project
b) keyable colors
c) keyable ints should remain ints when interpolated

12) Export Utility
a) converter?
b) push to browser

13) Modal Windows
a) file select
b) color select
c) confirm
d) alert
e) field (prompt)

14) Operations
a) Undo Command
   i) override browser default?
   ii) use browser functions?
b) File Saving
   i) Changing things cause file to become unsaved
   ii) Unsaved files are indicated (* in the title?)
   iii) loading a file should cause animatable time to update, as well as cause refresh on animatable items.
c) New nodes should be created somplace sensible, instead of a pre-defined position.

Some exemplary server-side considerations include but are not limited to:

1) Formats
a) jpg
b) exr
c) dpx/cin
d) tif
e) tga
f) png g) r3d

2) Multithreaded

3) Nuke patch layer

4) Auto build proxies

Exemplary additional considerations include:

1) Make color field wider for splines.

2) Responsiveness should be high when dragging nodes for a long period and fory groups of nodes.

3) Clients include mobile devices such as iPads.
a) The client application includes commands/gestures/touch events

With this disclosure, those skilled in the art will now appreciate that the methods and systems disclosed herein may be adapted for many different types of computationally and time-intensive tasks in the the visual effects industry and in other industries.

The methods and systems may be implemented on any computer communicating over any network. For example the computers may include desktop computers, tablets, handheld devices, laptops and mobile devices. The mobile devices may comprise many different types of mobile devices such as cell phones, smart phones, PDAs, portable computers, tablets, and any other type of mobile device operable to transmit and receive electronic messages.

The methods and systems may operate with visual effects and image processing software currently available to those skilled in the art. This may be done by way of an application programming interface (API) or equivalent, by direct integration, alone and in combination. Examples of such software include but are not limited to ROTOSHOP, SILHOUETTE, MOCHA, AFTER EFFECTS, COMBUSTION, DIGITAL FUSION, and the like. Communications with these and other programs may be via a network and video or image processing may be distributed according to, for example, processing requirements, software capabilities, network bandwidth, and the like.

The methods and systems may be implemented on any computer communicating over any network. For example the computers may include desktop computers, tablets, handheld devices, laptops and mobile devices. The mobile devices may comprise many different types of mobile devices such as cell phones, smart phones, PDAs, portable computers, tablets, and any other type of mobile device operable to transmit and receive electronic messages.

The computer network(s) may include the internet and wireless networks such as a mobile phone network. Any reference to a “computer” is understood to include one or more computers operable to communicate with each other. Computers and devices comprise any type of computer capable of storing computer executable code and executing the computer executable code on a microprocessor, and communicating with the communication network(s). For example computer may be a web server.

References to electronic identifiers may be used which include, but are not limited to, email addresses, mobile phone numbers, user IDs for instant messaging services, user IDs for social networking application or mobile applications, user IDs and URLs for blogs and micro-blogs, URIs, bank account or financial institution numbers, routing numbers, credit and debit cards, any computer readable code, and other electronic identifiers to identify accounts, users, companies, and the like.

The systems and methods may be implemented on an Intel or Intel compatible based computer running a version of the Linux operating system or running a version of Microsoft Windows, Apple OS, and other operating systems. Computing devices based on non-Intel processors, such as ARM devices may be used. Various functions of any server, mobile device or, generally, computer may be implemented in hardware and/or in software, including in one or more signal processing and/or application specific integrated circuits.

The computers and, equivalently, mobile devices may include any and all components of a computer such as storage like memory and magnetic storage, interfaces like network interfaces, and microprocessors. For example, a computer comprises some of all of the following: a processor in communication with a memory interface (which may be included as part of the processor package) and in communication with a peripheral interface (which may also be included as part of the processor package); the memory interface is in communication via one or more buses with a memory (which may be included, in whole or in part, as part of the processor package; the peripheral interface is in communication via one or more buses with an input/output (I/O) subsystem; the I/O subsystem may include, for example, a graphic processor or subsystem in communication with a display such as an LCD display, a touch screen controller in communication with a touch sensitive flat screen display (for example, having one or more display components such as LEDs and LCDs including sub-types of LCDS such as IPS, AMOLED, S-IPS, FFS, and any other type of LCD; the I/O subsystem may include other controllers for other I/O devices such as a keyboard; the peripheral interface may be in communication with either directly or by way of the I/O subsystem with a storage controller in communication with a storage device such a hard drive, non-volatile memory, magnetic storage, optical storage, magneto-optical storage, and any other storage device capable of storing data; the peripheral interface may also be in communication via one or more buses with one or more of a location processor such as a GPS and/or radio triangulation system, a magnetometer, a motion sensor, a light sensor, a proximity sensor, a camera system, wireless communication subsystem(s), and audio subsystems.

A non-transitory computer readable medium, such as the memory and/or the storage device(s) includes/stores computer executable code which when executed by the processor of the computer causes computer to perform a series of steps, processes, or functions. The computer executable code may include, but is not limited to, operating system instructions, communication instruction, GUI (graphical user interface) instructions, sensor processing instructions, phone instructions, electronic messaging instructions, web browsing instructions, media processing instructions, GPS or navigation instructions, camera instructions, magnetometer instructions, calibration instructions, an social networking instructions.

An application programming interface (API) permits the systems and methods to operate with other software platforms such as Salesforce CRM, Google Apps, Facebook, Twitter, social networking sites, desktop and server software, web applications, mobile applications, and the like. For example, an interactive messaging system could interface with CRM software and GOOGLE calendar.

A computer program product may include a non-transitory computer readable medium comprising computer readable code which when executed on the computer causes the computer to perform the methods described herein. Databases may comprise any conventional database such as an Oracle database or an SQL database. Multiple databases may be physically separate, logically separate, or combinations thereof.

The features described can be implemented in any digital electronic circuitry, with a combination of digital and analogy electronic circuitry, in computer hardware, firmware, software, or in combinations thereof. The features can be implemented in a computer program product tangibly embodied in an information carrier (such as a hard drive, solid state drive, flash memory, RAM, ROM, and the like), e.g., in a machine-readable storage device or in a propagated signal, for execution by a programmable processor; and method steps can be performed by a programmable processor executing a program of instructions to perform functions and methods of the described implementations by operating on input data and generating output(s).

The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any type of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. Some elements of a computer are a processor for executing instructions and one or more memories for storing instructions and data. Generally, a computer will also include, or communicate with one or more mass storage devices for storing data files. Exemplary devices include magnetic disks such as internal hard disks and removable disks, magneto-optical disks, and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) for displaying information to the user and a keyboard and a pointing device such as a mouse or a trackball by which the user can provide input to the computer. The display may be touch sensitive so the user can provide input by touching the screen.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, wired and wireless packetized networks, and the computers and networks forming the Internet.

The foregoing detailed description has discussed only a few of the many forms that this invention can take. It is intended that the foregoing detailed description be understood as an illustration of selected forms that the invention can take and not as a definition of the invention. It is only the claims, including all equivalents, that are intended to define the scope of this invention.

What is claimed is:

1. A rotoscoping method comprising the steps of providing a video, providing a plurality of editors, and editing the video on computers of the plurality of editors.
